(19) United States
(12) Patent Application Publication
(10) Pub. No.: US 2026/0084298 A1
(43) Pub. Date: Mar. 26, 2026

(54) SKETCH-BASED ROBOTIC POLICY FOR MANIPULATION TASKS

(71) Applicant: Intrinsic Innovation LLC, Mountain View, CA (US)

(72) Inventors: Priya Anandhi Sundaresan, Sunnyvale, CA (US); Stefan Schaal, Mountain View, CA (US)

(21) Appl. No.: 19/336,192

(22) Filed: Sep. 22, 2025

Related U.S. Application Data
(60) Provisional application No. 63/697,367, filed on Sep. 20, 2024.

(51) Int. Cl. B25J 9/16; G06N 20/00

(52) U.S. Cl. CPC B25J 9/163; B25J 9/1661; B25J 9/1697; G06N 20/00

(57) ABSTRACT

Methods, systems, and apparatus, including computer programs encoded on computer storage media, for sketch-based robotic control. One of the methods includes receiving data representing a sketch of a scene in a workcell, wherein the sketch represents a goal state to be achieved by a physical robot and includes one or more lines representing an object to be manipulated in the workcell. The sketch of the scene is provided as input to a trained machine learning model that implements a policy that maps sketches to actions required to achieve the goal state. The robot executes the actions generated by the machine learning model based on the sketch to manipulate an object in the workcell according to the actions.

### CROSS-REFERENCE TO RELATED APPLICATIONS

This application claims the benefit under 35 U.S.C. § 119 (e) of the filing date of U.S. Provisional Patent Application No. 63/697,367, filed on Sep. 20, 2024, entitled “SKETCH-BASED ROBOTIC POLICY FOR MANIPULATION TASKS,” the entirety of which is herein incorporated by reference.

### BACKGROUND

This specification relates to robotics, and more particularly to determining robotic policies for achieving a particular goal state.

Robotics control refers to controlling the physical movements of robots in order to perform tasks. For example, a robot can be programmed to pick up an object out of a bin and to place the object at a particular location in a workcell. Each of these actions can themselves include dozens or hundreds of individual movements by robot motors and actuators.

Robotics planning has traditionally required immense amounts of manual programming in order to meticulously dictate how the robotic components should move in order to accomplish a particular task. However, manual programming is error prone and does not generalize well to other environments.

Some research has been conducted toward using natural language inputs to specify goal states, including using language models to deduct the meaning of the natural language inputs. For example, a user can specify the natural language input, “place the hammer on the table,” and a language model can be used to understand this input and to generate a control policy that causes the robot to move to the goal state corresponding to the natural language input.

However, natural language inputs can be highly ambiguous and underspecified. For example, the example natural language input above can be ambiguous if there are multiple tables in the workcell, and it can be underspecified if the location on the table is important.

### SUMMARY

This specification describes how a system can use machine learning techniques in order to leverage information in sketches for automatically generating robotic control policies.

In this specification, a sketch is a line drawing corresponding to a view of a camera in a workcell. A sketch has the following properties. First, a sketch has a corresponding image captured by a camera. In other words, a companion image is available that has more information about a scene than the sketch. Second, a sketch includes lines that are relevant for completing a manipulation task. Lines of a sketch that are relevant for completing an object manipulation task typically correspond to actual physical features in the workcell, e.g., table edges and drawer handles, to name just two examples. Third, the lines of a sketch include one or more lines representing the object to be manipulated. Lastly, the lines of a sketch do not represent objects that are not present in the corresponding image.

A sketch can be input in a number of ways. For example, using a tablet computer that displays an image of a goal scene in a workcell, a user can use a finger, stylus, or any other appropriate input device, to draw task-relevant lines within the image. However, a sketch need not be generated by a human. Sketches can also be generated automatically from corresponding images, which can be used for training data generation.

Particular embodiments of the subject matter described in this specification can be implemented so as to realize one or more of the following advantages. Using the techniques described in this specification, users can more easily and naturally specify goal states to a robotic control system. This makes the robotic processes more accurate than language based inputs because the sketches unambiguously augment information about the goal state. The sketches also help to reduce the influence of visual noise in cluttered environments, which makes the corresponding robotic processes more effective.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram that illustrates an example architecture of a system that can implement sketch-based robotic control.

FIG. 2 is a flowchart of an example process for using a sketch for robotics control.

FIG. 3 is a flowchart of an example process for training a model to use sketch-based robotic control.

Like reference numbers and designations in the various drawings indicate like elements.

### DETAILED DESCRIPTION

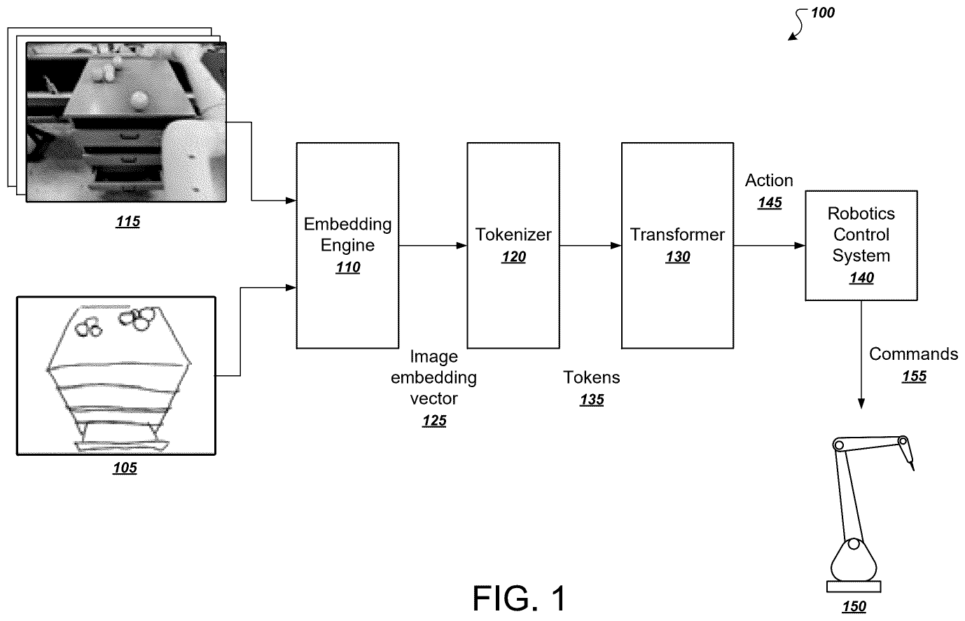

FIG. 1 is a diagram that illustrates an example architecture of a system 100 that can implement sketch-based robotic control. In general, the system 100 takes as input a goal sketch 105 and a history of images 115 corresponding to the sketch. The system 100 can then output an action 145 that is provided to a robotics controls system 140, which translates the action 145 into one or more commands 155 to drive a physical robot 150. The system can repeatedly process the goal sketch 105 and the history of images 115 at each time step until the goal is reached or until another stopping condition is reached, e.g., a maximum number of steps.

The history of images 115 can be captured by one or more cameras in an operating environment of the robot 150. In some implementations, the user specifies the goal sketch 105 using a first image captured from a camera that will also be supplying the history of images 115 during execution of the process. Thus at each time step, after the robot 150 has executed commands 155 corresponding to the most-recently generated action 145, the system can update the history of images 115 by capturing a new image and removing the oldest image from the history of images 115. Alternatively, the system can use all previously captured images as the history of images 115.

In general, each image in the history of images will have more visual data than the goal sketch 105. For example, in some implementations, the history of images 115 are RGB color images, while the goal sketch 105 is a monochrome line drawing, e.g., a black-and-white line drawing. As illustrated in this example, the goal sketch 105 indicates that apples on a table should be placed into two piles near the back corners of a working surface, while the most recent image in the history of images 115 shows that the goal has not yet been reached because only one pile has so far been created.

The goal sketch 105 and the history of images 115 are first processed by an embedding engine 110, which is a machine-learning subsystem executing on one or more computers in one or more places. The embedding engine is configured through training to receive a goal sketch 105 and a corresponding history of images 115 and to generate a corresponding feature representation. The embedding engine 110 can apply a sequence of learned transformations to extract multi-level visual characteristics of the images and can output a numerical image embedding vector. The image embedding vector encodes distinguishing features of the input images in a reduced-dimensional space, thereby facilitating subsequent processing operations.

The image embedding vector is then pass through a tokenizer 120, which is another machine learning subsystem executing on one or more computers in one or more places. The tokenizer is configured to receive an image embedding vector corresponding to the goal sketch 105 and the history of images 115 image and to generate a reduced set of tokens 135 that capture the most informative aspects of the image embedding vector 125. The tokenizer 120 essentially evaluates portions of the image embedding vector and selects or transforms it into a more compact representation. This process can decrease the dimensionality of the image embedding vector while preserving semantic information.

The tokens 135 are then provided as input to a transformer 130, which is another machine learning subsystem executing on one or more computers in one or more locations. The transformer 130 can be any appropriate machine learning system that uses integrated self-attention to transform an input sequence into an output sequence.

In this example, the output can specify an action encoded as one or more goal parameters of the robot 150. For example, the goal parameters can specify a goal state for an end effector, e.g., a six-dimensional pose, along with optionally one or more parameters for a gripper, e.g., gripper width. The goal parameters can also specify a goal state for a base of the robot 150. In some implementations, the action 145 also encodes a flag that specifies whether to move the robot arm, the robot base, or to terminate the process. For example, if the transformer 130 does not have high confidence in the output, the flag can be set to terminate the process by the robotics control system 140.

The robotics control system 140 translates the generated action into one or more commands 155 that drive the physical robot. The robotics control system 140, or another system, can also coordinate the capture of a most recent image for the next batch of the history of images 115.

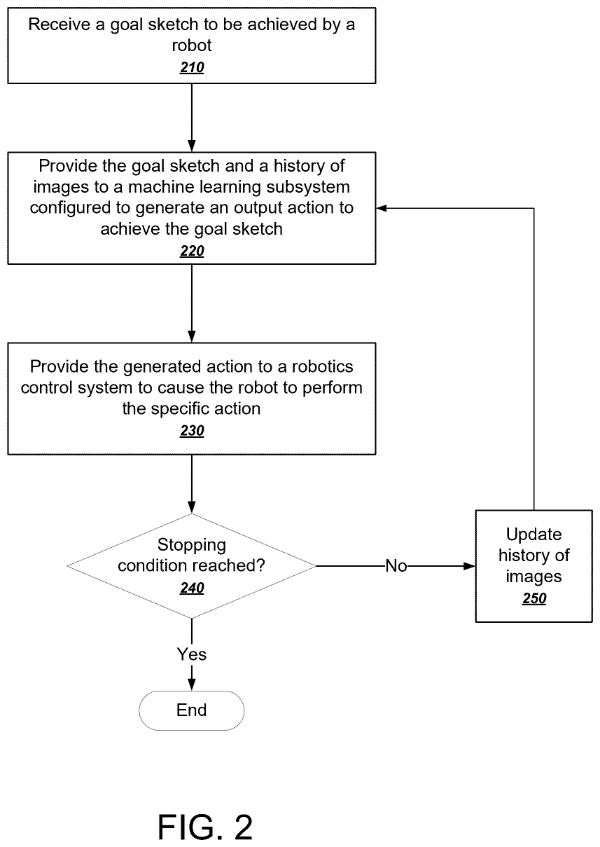

FIG. 2 is a flowchart of an example process for using a sketch for robotics control. The example process can be performed by a system of one or more computers in one or more places that includes a robotics control system in communication with a robot. The process will be described as being performed by a system of one or more computers.

The system receives a goal sketch to be achieved by a robot (210). As described above, a goal sketch is a line drawing that is based on a camera image of a robotic workcell in which objects are to be manipulated. Thus, each line in a goal sketch corresponds to a location in the camera image and therefore also a location in the robotic workcell.

A goal sketch can specify a variety of different outcomes. As one example, a goal sketch can specify the desired location for one or more objects in the workcell. As another example, a goal sketch can specify a desired orientation of an object in a workcell. For example, if a cylindrical object is laying on its side, the sketch can specify that the object should be repositioned so that it is upright, e.g., resting on one of its circular ends. As another example, a goal state can specify a manipulation of an object in the workcell, e.g., the opening or closing of a drawer. Regardless of the desired outcome, the goal sketch will cause the system to keep generating and performing actions that bring the state of objects in the workcell closer and closer toward what is depicted by the goal sketch.

In order to specify goal sketches, the system can provide a specialized user interface presentation on any appropriate user device, e.g., a mobile phone, a tablet computer, or a desktop computer that is capable of inputting lines. The specialized user interface displays a camera image of the workcell including one or more objects to be manipulated. A user can then specify the goal sketch by providing input that generates lines overlaying the camera image. For example, in some implementations, the user interface can be displayed on a tablet computer, and a user can use a stylus to make the lines of the goal sketch on top of the displayed camera image.

The system provides the goal sketch and a history of images to a machine learning subsystem configured to generate an output action in order to achieve the goal sketch (220). As described above with reference to FIG. 1, the machine learning subsystem can have multiple layers that transform the goal sketch and the history of images into an action to be performed that moves the system closer to the state indicated by the goal sketch. For example, the system can use a combination of an embedding engine, a tokenizer, and a transformer in sequence to generate output actions.

The system provides the generated action to a robotics control system to cause the robot to perform the specified action (230). Often, the specified action results in the robot performing commands to manipulate an object in the workcell. The specified action can also relate to repositioning the end effector of a robot at a particular pose or at a particular location.

The system determines whether a stopping condition has been reached (240). One example stopping condition is the system achieving the goal state. To do so, the system can compute an evaluation metric that measures a distance between the state of the workcell and the state specified by the goal sketch. In some implementations, the system can compute an aggregated distance measure that is based on distances between object centroids specified in the goal sketch and their corresponding locations in the most recent camera image. When the aggregated distance measure becomes lower than a threshold, the system can consider the goal state to have been reached. Another example stopping condition is exceeding a maximum number of time steps. In addition, the generated action itself might encode that a stopping condition has been reached, e.g., because as judged by the transformer, there is a low probability of the robot ever manipulating the objects into the state specified by the goal sketch.

If the stopping condition is reached (240), the process ends (branch to end).

Otherwise, the system updates the history of images (branch to 250). For example, the system can capture a new image of the workcell and add the new image to the history of images while removing the oldest image from the history of images. The process then loops back to step 220 wherein the goal sketch and the history of images are again provided to the machine learning subsystem to generate a next action for achieving the goal state specified by the goal sketch.

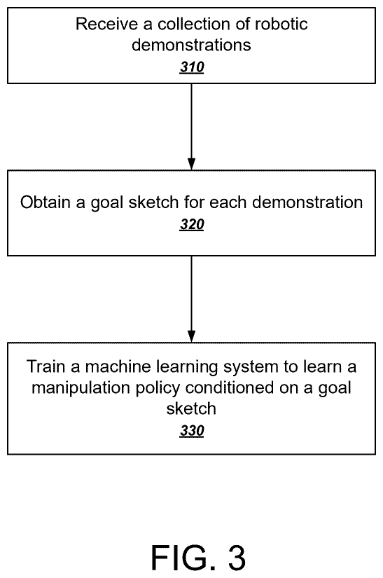

FIG. 3 is a flowchart of an example process for training a model to use sketch-based robotic control. The example process can be performed by a system of one or more computers in one or more places. The process will be described as being performed by a system of one or more computers.

The system receives a collection of robotic demonstrations (310). Each robotic demonstration includes data representing a trajectory taken by a robot during a previous manipulation task along with video or camera data that captured the performance of the manipulation task. For example, each demonstration can include a video of a robot manipulating an object as well as trajectory data for the robot manipulating the object.

The system obtains a goal sketch for each demonstration (320). The overall objective is to learn a manipulation policy corresponding to the demonstrated trajectory that is conditioned on a goal sketch. The system could receive human-provided goal sketches for each of the demonstrations, but for many applications this approach is slow and impractical.

Therefore, the system can instead use an image-to-sketch translation network, which is a machine learning system that is configured through training to generate sketches from images. Using the image-to-sketch translation network, the system can simply use the last image of the demonstration to automatically generate a goal sketch for each of the demonstrations.

To train the image-to-sketch translation network, the system can obtain a number of pairs of images depicting robotic manipulation tasks along with human-annotated sketches of the images. In some implementations, the system can augment this dataset with other image-to-sketch datasets that do not relate to robotic manipulation in order to train for inter-sketch variation.

The system trains a machine learning system to learn a manipulation policy conditioned on a goal sketch (330). As described above, the inputs to the machine learning subsystem are a goal sketch and a history of images. Thus, for training the system can use a goal sketch generated for a demonstrated trajectory along with an appropriate range of camera images from the demonstration data. The system can then pass the generated goal sketch and camera images through the network to generate a corresponding action. Rather than using the action to drive a robot, during train the generated action is only used to update the weights of the model, which can be done in an end-to-end fashion.

In some implementations, the system uses a behavioral cloning objective function. In other words, the generated action is compared to the corresponding action from the successful demonstration in order to update the weights of the model so that the next time the system encounters the same or a similar action, the system will generate an action that was closer to the action from the demonstration trajectory.

In some implementations, the system updates the weights of the model to minimize the negative log-likelihood of the generated actions according to:

$$J ( {π}_{sketch} ) = {\sum }_{n = 1}^{N} {\sum }_{t = 1}^{{T}^{( n )}} log {π}_{sketch} ( {a}_{t}^{n} \vert {g}^{n} , {\{ {o}_{j} \}}_{j = 1}^{t} ) ,$$

where π_{sketch} indicates the machine learning subsystem that seeks to generate an action a given a goal sketch g along with a history of observations o. In this formulation, N is the number of demonstrations and T⁽ⁿ⁾ is a length of the nth trajectory in time steps.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them. The computer storage medium is not, however, a propagated signal.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving data representing a sketch of a scene in a workcell, wherein the sketch represents a goal state to be achieved by a physical robot and includes one or more lines representing an object to be manipulated in the workcell;
providing the sketch of the scene as input to a trained machine learning model that implements a policy that maps sketches to actions required to achieve the goal state; and
causing the robot to manipulate an object in the workcell according to actions generated by the machine learning model based on the sketch.

2. The method of claim 1, further comprising providing one or more history images as input to the trained machine learning model, wherein the machine learning model is configured to implement the policy based on a sketch of the goal state as well as the one or more history images.

3. The method of claim 1, wherein the sketch is a line drawing comprising a plurality of lines.

4. The method of claim 3, wherein the sketch includes lines that are relevant to completing a manipulation task.

5. The method of claim 4, wherein the machine learning model takes as further input a history of image observations.

6. The method of claim 5, further comprising training the machine learning model using a dataset comprising sets of images and corresponding sketches.

7. The method of claim 6, further comprising training a sketch generation model that generates sketches from input images.

8. The method of claim 6, further comprising augmenting the dataset using pairs of images and sketches generated by the sketch generation model.

9. The method of claim 1, wherein the machine learning model includes a transformer layer.

10. The method of claim 1, further comprising:
receiving a demonstration dataset comprising trajectory information and a plurality of images for each demonstration in the demonstration dataset;
generating, for each demonstration, a goal sketch from a single image of the plurality of images from the demonstration; and
training the machine learning model using the demonstrations and the generated goal sketches to minimize an error between actions performed in the demonstrations and actions generated by the model based on the goal sketches.

11. The method of claim 10, further comprising:
training an image-to-sketch network that is configured to generate a sketch from an image,
wherein generating each goal sketch from images in the demonstration comprises using the trained image-to-sketch network.

12. The method of claim 11, wherein training the image-to-sketch network comprises using images manually annotated with sketches along with non-robotic image and sketch pairs.

13. A system comprising:
one or more computers and one or more storage devices storing instructions that are operable, when executed by the one or more computers, to cause the one or more computers to perform operations comprising:
receiving data representing a sketch of a scene in a workcell, wherein the sketch represents a goal state to be achieved by a physical robot and includes one or more lines representing an object to be manipulated in the workcell;
providing the sketch of the scene as input to a trained machine learning model that implements a policy that maps sketches to actions required to achieve the goal state; and
causing the robot to manipulate an object in the workcell according to actions generated by the machine learning model based on the sketch.

14. The system of claim 13, wherein the operations further comprise providing one or more history images as input to the trained machine learning model, wherein the machine learning model is configured to implement the policy based on a sketch of the goal state as well as the one or more history images.

15. The system of claim 13, wherein the sketch is a line drawing comprising a plurality of lines.

16. The system of claim 15, wherein the sketch includes lines that are relevant to completing a manipulation task.

17. The system of claim 16, wherein the machine learning model takes as further input a history of image observations.

18. The system of claim 17, wherein the operations further comprise training the machine learning model using a dataset comprising sets of images and corresponding sketches.

19. The system of claim 18, wherein the operations further comprise training a sketch generation model that generates sketches from input images.

20. One or more non-transitory computer storage media encoded with computer program instructions that when executed by one or more computers cause the one or more computers to perform operations comprising:
receiving data representing a sketch of a scene in a workcell, wherein the sketch represents a goal state to be achieved by a physical robot and includes one or more lines representing an object to be manipulated in the workcell;
providing the sketch of the scene as input to a trained machine learning model that implements a policy that maps sketches to actions required to achieve the goal state; and
causing the robot to manipulate an object in the workcell according to actions generated by the machine learning model based on the sketch.
